(19) United States
(12) Patent Application Publication
(10) Pub. No.: US 2016/0177131 A1
(43) Pub. Date: Jun. 23, 2016

(54) Siloxane Resin and Coating Solution Composition Comprising the Same

(71) Applicant: Samsung SDI Co., Ltd., Yongin-si (KR)

(72) Inventors: Chang Soo WOO, Uiwang-si (KR); Yukinari HARIMOTO, Uiwang-si (KR); Hyung Rang MOON, Uiwang-si (KR); Woo Jin LEE, Uiwang-si (KR); Hak Gyeong LEE, Uiwang-si (KR); Seung Woo JANG, Uiwang-si (KR); Dong Il HAN, Uiwang-si (KR)

(21) Appl. No.: 14/939,341

(22) Filed: Nov. 12, 2015

(30) Foreign Application Priority Data
Dec. 19, 2014 (KR) 10-2014-0185001

(51) Int. Cl. C09D 183/06; C08G 77/14

(52) U.S. Cl. CPC C09D 183/06; C08G 77/14

(57) ABSTRACT

A siloxane resin is a polymer of a monomer mixture including a compound represented by Formula 1, a compound represented by Formula 2, and a compound represented by Formula 3. A coating solution composition including the siloxane resin can form a coating layer exhibiting excellent properties in terms of abrasion resistance, weather resistance and the like.

### CROSS-REFERENCE TO RELATED APPLICATION

This application claims priority under 35 USC Section 119 to and the benefit of Korean Patent Application 10-2014-0185001, filed Dec. 19, 2014, the entire disclosure of which is incorporated herein by reference.

### FIELD OF THE INVENTION

The present invention relates to a siloxane resin and a coating solution composition including the same.

### BACKGROUND

Recently, the automotive industry confronts issues such as fuel efficiency improvement, reduced emissions, passenger safety, cost reduction due to fierce competition between automobile companies, and the like. To solve these problems, various studies for replacing window glass for window modules, soft steel plates for vehicle bodies and the like with lightweight metals, plastics, carbon composite materials and the like have been actively carried out.

In particular, plastic materials have contributed to weight reduction of automobiles, improvement in freedom of design, impartment of novel functions and cost reduction, are expected to contribute to development of novel techniques for addressing environmental problems, and are preferred as alternative materials for components, such as automotive window glass, which are difficult to manufacture from resins by typical techniques.

For example, plastic materials such as polycarbonate (PC), polymethyl methacrylate (PMMA) and the like are used in the manufacture of various automotive components such as B-fillers, headlamps, sunroofs and the like due to excellent impact resistance, transparency and moldability thereof. In particular, the plastic materials can provide various merits and serve various purposes in terms of styling/design, weight reduction, and stability/safety of automotive window modules. For example, since plastic materials can increase overall design and shape complexity, the plastic materials can allow a vehicle to be differentiated from vehicles of competitors and provide capabilities of reducing complexity of a window assembly to automobile manufacturers by integrating functional components into a molded plastic module. Use of a lightweight plastic window module can facilitate a low center of gravity and fuel economy of vehicles. In addition, a plastic window module can increase overall stability of vehicles by reinforcing support for passengers in the event of rollover.

However, a plastic material such as polycarbonate has poor scratch resistance and abrasion resistance. To improve such scratch resistance or abrasion resistance, a method for forming a coating layer on a plastic substrate is being studied. Generally, a compound used for a coating composition (abrasion resistant coating agent) for forming a coating layer includes acrylic polymers, urethane polymers, epoxy polymers, silicon polymers, silica compounds, and the like. With increasing crosslinking density of coating agents, most coating agents can suffer from warpage or cracks due to shrinkage of a coating layer despite improved abrasion resistance and suffer from deformation at a coating joint. Thus, there is a concern that most of the coating agents are likely to be peeled off even by slight touch due to reduced adhesion to a material. In addition, although most coating agents exhibit increased hardness and abrasion resistance with increasing coating thickness, there is a limit in increase of hardness and abrasion resistance, and deterioration in adhesion of the coating agents to a lower substrate ultimately deteriorates weather resistance.

Therefore, there is a need for development of a coating solution composition capable of forming a coating layer exhibiting excellent abrasion resistance, weather resistance, and the like.

### SUMMARY OF THE INVENTION

Embodiments provide a novel siloxane resin capable of forming a coating layer exhibiting excellent abrasion resistance, weather resistance and the like, a coating solution composition including the siloxane resin, and a molded article including a coating layer formed of the coating solution composition.

The siloxane resin is a polymer of a monomer mixture including a compound represented by Formula 1, a compound represented by Formula 2, and a compound represented by Formula 3:

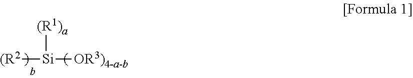

where R¹ is an epoxy or glycidoxy group-containing C₁ to C₁₂ alkyl group, R² is a hydrogen atom or a substituted or unsubstituted C₁ to C₁₀ alkyl group, R³ is a substituted or unsubstituted C₁ to C₁₀ alkyl group, an average value of a is 1 to 3, an average value of b is 0 to 2, and an average value of a+b is 1 to 3;

R⁴—SiOR⁵)₃ [Formula 2]

where R⁴ is a hydrogen atom or a substituted or unsubstituted C₁ to C₁₀ alkyl group, and R⁵ is a substituted or unsubstituted C₁ to C₁₀ alkyl group;

R⁶—SiOR⁷)₃ [Formula 3]

where R⁶ is a UV absorbing functional group or a UV absorbing functional group-containing group, and R⁷ is a substituted or unsubstituted C₁ to C₁₀ alkyl group.

In exemplary embodiments, the UV-absorbing functional group may include at least one of substituted or unsubstituted benzotriazole groups, substituted or unsubstituted benzophenone groups, substituted or unsubstituted triazine groups, substituted or unsubstituted salicylate groups, substituted or unsubstituted cyanoacrylate groups, and substituted or unsubstituted oxanilide groups.

In exemplary embodiments, the compound represented by Formula 1 may be present in an amount of about 0.50 mol % to about 99.45 mol %, the compound represented by Formula 2 may be present in an amount of about 0.50 mol % to about 99.45 mol %, and the compound represented by Formula 3 may be present in an amount of about 0.05 mol % to about 10 mol %, each based on a total of 100 mol % of the monomer mixture.

In exemplary embodiments, the monomer mixture may further include a compound represented by Formula 4:

(R⁸SiOR⁹)_{4-c} [Formula 4]

wherein R⁸ is a hydrogen atom or a substituted or unsubstituted C₁ to C₁₀ alkyl group; R⁹ is a substituted or unsubstituted C₁ to C₁₀ alkyl group; and c is 0, 2 or 3.

In exemplary embodiments, the polymer may have a weight average molecular weight of about 800 g/mol to about 30,000 g/mol.

Other embodiments relate to a coating solution composition. The coating solution composition includes: a binder including the siloxane resin as set forth above; and a phosphorus catalyst.

In exemplary embodiments, the phosphorus catalyst may include a compound represented by Formula 5:

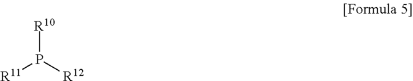

wherein R¹⁰, R¹¹ and R¹² are the same or different and are each independently a substituted or unsubstituted C₁ to C₂₀ hydrocarbon group.

In exemplary embodiments, the phosphorus catalyst may be present in an amount of about 0.01 to about 25 parts by weight based on about 100 parts by weight of the siloxane resin.

In exemplary embodiments, the coating solution composition may further include a solvent.

In exemplary embodiments, the coating solution composition may further include at least one of fillers, UV absorbers, quenchers, hindered amine light stabilizers, antioxidants, leveling agents, and curing agents.

Other embodiments relate to a molded article. The molded article includes: a polycarbonate substrate; and a coating layer formed on at least one surface of the substrate, wherein the coating layer is a cured product of the coating solution composition as set forth above.

In exemplary embodiments, the polycarbonate substrate may have a thickness of about 1 mm to about 50 mm, and the coating layer may have a thickness of about 0.1 μm to about 20 μm.

In exemplary embodiments, the molded article may further include a primer layer formed between the polycarbonate substrate and the coating layer.

### BRIEF DESCRIPTION OF THE DRAWINGS

FIG. 1 is a sectional view of a molded article according to one embodiment of the present invention.

FIG. 2 is a sectional view of a molded article according to another embodiment of the present invention.

### DETAILED DESCRIPTION

Hereinafter, embodiments of the present invention will be described in detail in the following detailed description in which some, but not all, embodiments are described. Indeed, this invention may be embodied in many different forms and should not be construed as limited to the embodiments set forth herein; rather, these embodiments are provided so that this disclosure will satisfy applicable legal requirements. It should be understood that the following embodiments are provided for complete disclosure and thorough understanding of the invention by those skilled in the art. In addition, unless otherwise stated, technical and scientific terms as used herein have a meaning generally understood by those skilled in the art. Descriptions of known functions and constructions which can unnecessarily obscure the subject matter of the invention will be omitted.

According to the present invention, a siloxane resin is a siloxane polymer including an epoxy group, a UV absorbing functional group and a siloxane bond (—Si—O—Si—), and is a polymer of a monomer mixture including a compound represented by Formula 1, a compound represented by Formula 2 and a compound represented by Formula 3.

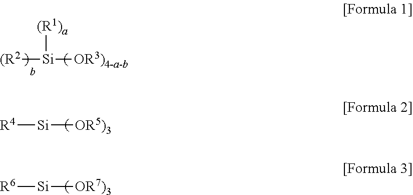

In Formulae 1, 2 and 3, R¹ is an epoxy or glycidoxy group-containing C₁ to C₁₂ alkyl group, for example, a glycidoxypropyl group, a glycidyl group, an epoxycyclohexyl group, or the like; R² and R⁴ are the same or different and are each independently a hydrogen atom or a substituted or unsubstituted C₁ to C₁₀ alkyl group, for example, a hydrogen atom, a methyl group, an ethyl group, a propyl group, an isopropyl group, a butyl group, an isobutyl group, a tert-butyl group, or the like; R³, R⁵ and R⁷ are the same or different and are each independently a substituted or unsubstituted C₁ to C₁₀ alkyl group, for example, a methyl group, an ethyl group, a propyl group, an isopropyl group, a butyl group, an isobutyl group, a tert-butyl group, or the like; and R⁶ is a UV absorbing functional group or a UV absorbing functional group-containing group.

As used herein, the term “UV absorbing functional group” refers to a functional group absorbing ultraviolet light having a wavelength of about 400 nm or less, for example, a wavelength of about 100 nm to about 400 nm. Examples of the UV absorbing functional group may include without limitation substituted or unsubstituted benzotriazole groups, substituted or unsubstituted benzophenone groups, substituted or unsubstituted triazine groups, substituted or unsubstituted salicylate groups, substituted or unsubstituted cyanoacrylate groups, substituted or unsubstituted oxanilide groups, and the like, and combinations thereof.

In addition, an average value of a is 1 to 3, an average value of b is 0 to 2, and an average value of a+b is 1 to 3.

As used herein, the term “substituted” means that a hydrogen atom is substituted with a substituent such as a halogen group, C₁ to C₁₀ alkyl group, C₁ to C₁₀ haloalkyl group, C₆ to C₁₂ aryl group, C₆ to C₁₂ heteroaryl group, C₁ to C₂₀ alkoxy group, and the like, and combinations thereof.

Examples of the compound represented by Formula 1 may include without limitation 3-glycidoxypropyltrimethoxysilane, 3-glycidoxypropylmethyldimethoxysilane, 3-glycidoxypropyltriethoxysilane, 3-glycidoxypropylmethyldiethoxysilane, 2-(3,4-epoxycyclohexyl)ethyltrimethoxysilane, 2-(3,4-epoxycyclohexyl)ethyltriethoxysilane, 5,6-epoxyhexyltriethoxysilane, 3-glycidoxypropyldimethylethoxysilane, 3-glycidoxypropyldimethylmethoxysilane, and the like, and mixtures thereof.

Examples of the compound represented by Formula 2 may include without limitation methyltrimethoxysilane, methyltriethoxysilane, trimethoxysilane, triethoxysilane, ethyltrimethoxysilane, ethyltriethoxysilane, n-propyltrimethoxysilane, n-propyltriethoxysilane, n-butyltrimethoxysilane, n-butyltriethoxysilane, isobutyltrimethoxysilane, isobutyltriethoxysilane, tert-butyltrimethoxysilane, tert-butyltriethoxysilane, and the like, and mixtures thereof.

In exemplary embodiments, R⁶ of the compound represented by Formula 3 may be represented by *—(R^{6a})ₙ—R^{6b}. As used herein, * represents a binding site for Si of Formula 3; R^{6a} is a linking group and is a substituted or unsubstituted C₁ to C₁₀ alkylene group, a substituted or unsubstituted C₁ to C₁₀ oxyalkylene group, a substituted or unsubstituted C₁ to C₁₀ alkylene group having a urethane bond at a terminal thereof or in the functional group, a substituted or unsubstituted C₆ to C₂₀ arylene group, or a combination thereof; n is 0 or 1; and R^{6b} is a substituted or unsubstituted benzotriazole group, a substituted or unsubstituted benzophenone group, a substituted or unsubstituted triazine group, a substituted or unsubstituted salicylate group, a substituted or unsubstituted cyanoacrylate group, a substituted or unsubstituted oxanilide group, or a combination thereof.

In exemplary embodiments, the compound represented by Formula 3 may be a commercially available product or may be a compound prepared by reacting a UV absorber known in the art with a trialkoxysilane having a functional group capable of reacting with the UV absorber. Examples of the UV absorber may include without limitation: hydroxyphenyltriazine UV absorbers such as Tinuvin 400, Tinuvin 405, Tinuvin 460, Tinuvin 479, and the like; hydroxyphenylbenzotriazole UV absorbers such as Tinuvin 99, Tinuvin 99-2, Tinuvin 171, Tinuvin 328, Tinuvin 384-2, Tinuvin 900, Tinuvin 928, Tinuvin 1130, Tinuvin 5050, Tinuvin 5060, and the like, and combinations thereof.

Examples of the trialkoxysilane may include without limitation isocyanate group-containing trialkoxysilanes, for example, trialkoxysilanes having an isocyanate group-containing C₁ to C₁₀ alkyl group and/or a C₁ to C₁₀ alkoxy group.

Reaction of the UV absorber with the trialkoxysilane may be performed at about 50° C. to about 200° C. for about 1 hour to about 5 hours. The reaction may be conducted using a solvent. Examples of the solvent may include organic solvents such as tetrahydrofuran and the like.

Upon reaction of the UV absorber with the trialkoxysilane, reaction yield may be increased by use of a catalyst. Examples of the catalyst may include without limitation tin catalysts such as dibutyltin dilaurate and the like.

In exemplary embodiments, the compound represented by Formula 1 may be present in an amount of about 0.50 mol % to about 99.45 mol %, for example, about 0.8 mol % to about 80 mol %, and as another example about 1 mol % to about 59.9 mol %, based on 100 mol % of the monomer mixture; the compound represented by Formula 2 may be present in an amount of about 0.50 mol % to about 99.45 mol %, for example, about 15 mol % to about 99 mol %, and as another example about 50 mol % to about 98.9 mol %, based on 100 mol % of the monomer mixture; and the compound represented by Formula 3 may be present in an amount of about 0.05 mol % to about 10 mol %, for example, about 0.1 mol % to about 7 mol %, and as another example about 0.1 mol % to about 3 mol %, based on 100 mol % of the monomer mixture.

In some embodiments, the monomer mixture may include the compound represented by Formula 1 in an amount of about 0.50, 0.60, 0.70, 0.80, 0.90, 1, 2, 3, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.10, 99.15, 99.20, 99.25, 99.30, 99.35, 99.40, or 99.45 mol %. Further, according to some embodiments of the present invention, the compound represented by Formula 1 may be present in an amount of from about any of the foregoing amounts to about any other of the foregoing amounts.

In some embodiments, the monomer mixture may include the compound represented by Formula 2 in an amount of about 0.50, 0.60, 0.70, 0.80, 0.90, 1, 2, 3, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.10, 99.15, 99.20, 99.25, 99.30, 99.35, 99.40, or 99.45 mol %. Further, according to some embodiments of the present invention, the compound represented by Formula 2 may be present in an amount of from about any of the foregoing amounts to about any other of the foregoing amounts.

In some embodiments, the monomer mixture may include the compound represented by Formula 3 in an amount of about 0.05, 0.06, 0.07, 0.08, 0.09, 0.10, 0.20, 0.30, 0.40, 0.50, 0.60, 0.70, 0.80, 0.90, 1, 2, 3, 3, 4, 5, 6, 7, 8, 9, or 10 mol %. Further, according to some embodiments of the present invention, the compound represented by Formula 3 may be present in an amount of from about any of the foregoing amounts to about any other of the foregoing amounts.

Within these ranges, a coating layer including the siloxane resin can exhibit excellent adhesion, abrasion resistance, weather resistance and the like.

In exemplary embodiments, the monomer mixture may further include a compound represented by Formula 4.

R⁸_{c}SiOR⁹)_{4-c} [Formula 4]

wherein R⁸ is a hydrogen atom or a substituted or unsubstituted C₁ to C₁₀ alkyl group, for example, a hydrogen atom, a methyl group, an ethyl group, a propyl group, an isopropyl group, a butyl group, an isobutyl group, a tert-butyl group, or the like; R⁹ is a substituted or unsubstituted C₁ to C₁₀ alkyl group, for example, a methyl group, an ethyl group, a propyl group, an isopropyl group, a butyl group, an isobutyl group, a tert-butyl group, or the like; and c is 0, 2 or 3.

In exemplary embodiments, the compound represented by Formula 4 may be present in an amount of about 10 parts by mol or less, for example, about 0.1 parts by mol to about 7 parts by mol, and as another example about 0.5 parts by mol to about 5 parts by mol, based on a total of about 100 parts by mol of the compounds represented by Formulae 1, 2 and 3. In some embodiments, the monomer mixture may include the compound represented by Formula 4 in an amount of 0 (the compound of Formula 4 is not present), about 0 (the compound of Formula 4 is present), 0.1, 0.2, 0.3, 0.4, 0.5, 0.6, 0.7, 0.8, 0.9, 1, 2, 3, 3, 4, 5, 6, 7, 8, 9, or 10 parts by mol. Further, according to some embodiments of the present invention, the compound represented by Formula 4 may be present in an amount of from about any of the foregoing amounts to about any other of the foregoing amounts.

Within this range, a coating layer including the siloxane resin can exhibit better abrasion resistance and the like, and can suffer from less cracking.

The siloxane resin may be prepared by a method known in the art. For example, the siloxane resin may be prepared by condensation of the monomer mixture, and may be prepared by hydrolysis of each of monomers, followed by condensation, as needed. Condensation, hydrolysis and the like can be easily performed by those skilled in the art. For example, the siloxane resin may be prepared by hydrolysis and condensation of the monomer mixture in the presence of water and a catalyst (acetic acid and the like), as in the preparative example described below.

In exemplary embodiments, the siloxane resin may have a branch structure, a ladder structure, a network structure, or a combination thereof, and may have a weight average molecular weight of about 800 g/mol to about 30,000 g/mol, for example, about 1,000 g/mol to about 10,000 g/mol, as measured by gel permeation chromatography (GPC). Within this range, the coating solution composition including the siloxane resin can exhibit excellent coatability, and the coating layer can exhibit excellent abrasion resistance, weather resistance and the like.

The coating solution composition can form a coating layer exhibiting excellent abrasion resistance, weather resistance and the like, and includes: a binder including the siloxane resin as set forth above; and a phosphorus catalyst.

In exemplary embodiments, the binder may include at least one of the siloxane resins, and may further optionally include a typical resin for binders, such as epoxy, amide, acrylic, urethane, and/or silicone resins, copolymers thereof, and the like and mixtures thereof, in order to improve mechanical properties of the coating layer, compatibility of the coating solution composition, and the like. When a resin for binders is used together with the siloxane resin, the resin for binders may be present in an amount of about 0.1 to about 100 parts by weight based on about 100 parts by weight of the siloxane resin, without being limited thereto.

In some embodiments, the coating solution composition may include the resin for binders in an amount of about 0.1, 0.2, 0.3, 0.4, 0.5, 0.6, 0.7, 0.8, 0.9, 1, 2, 3, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 parts by weight based on about 100 parts by weight of the siloxane resin. Further, according to some embodiments of the present invention, the resin for binders may be present in an amount of from about any of the foregoing amounts to about any other of the foregoing amounts.

In addition, the binder may be used in a state (solution) in which solids such as the siloxane resin and the like are dissolved in a solvent, without being limited thereto. The solvent may be any solvent so long as the solvent has no reactivity with the binder (solids) and can dissolve the binder. Examples of the solvent may include without limitation: C₁ to C₁₅ alcohols; C₁ to C₂₀ hydrocarbon solvents such as C₁ to C₂₀ aliphatic hydrocarbons, C₅ to C₂₀ alicyclic hydrocarbons, C₆ to C₂₀ aromatic hydrocarbons and the like; halogenated C₁ to C₂₀ hydrocarbon solvents; C₂ to C₂₀ ethers such as C₂ to C₂₀ aliphatic ethers, C₅ to C₂₀ alicyclic ethers and the like; and mixtures thereof. If the binder is in a solution state, the amount of the solvent is not particularly limited so long as the amount of the solvent can allow the binder solid such as the siloxane resin and the like to be dissolved. For example, the solvent may be present in an amount of about 900 parts by weight or less based on about 100 parts by weight of the binder solid.

In exemplary embodiments, the phosphorus catalyst is a curing catalyst for formation of a coating layer, and may include, for example, a compound represented by Formula 5.

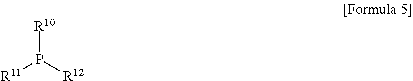

wherein R¹⁰, R¹¹ and R¹² are the same or different and are each independently a substituted or unsubstituted C₁ to C₂₀ hydrocarbon group. As used herein, unless otherwise defined, the term hydrocarbon group refers to a substituted or unsubstituted C₆ to C₂₀ aryl group, a substituted or unsubstituted C₅ to C₂₀ cycloalkyl group including or not including a heteroatom such as an oxygen atom (O), a nitrogen atom (N) and the like, or a substituted or unsubstituted C₁ to C₂₀ alkyl group.

For example, R¹⁰, R¹¹ and R¹² may be each independently a substituted or unsubstituted C₆ to C₂₀ aryl group, a substituted or unsubstituted C₅ to C₂₀ cycloalkyl group including or not including a heteroatom such as an oxygen atom (O), a nitrogen atom (N) and the like, or a substituted or unsubstituted C₁ to C₂₀ alkyl group. For example, R¹⁰, R¹¹ and R¹² may be the same or different and may be each independently an aryl group such as a phenyl group, a tolyl group and the like, a cycloalkyl group such as a cyclohexyl group, a glycidoxypropylcyclohexyl group and the like, or an alkyl group such as an ethyl group, a propyl group, a butyl group, and the like.

Examples of the phosphorus catalyst may include without limitation triphenylphosphine, tri(p-tolyl)phosphine, triisopropylphosphine, and the like, and mixtures thereof.

In exemplary embodiments, the phosphorus catalyst may be present in an amount of about 0.01 to about 25 parts by weight, for example, about 1 to about 10 parts by weight, based on about 100 parts by weight of the binder (in terms of solid content). Within this range, the coating layer can exhibit excellent degree of cure when the coating layer is formed.

In exemplary embodiments, the coating solution composition may further include a solvent. The solvent may be any solvent so long as the solvent can dissolve the binder while having no reactivity with the binder and can be evaporated upon formation of the coating layer. The solvent may be selected in consideration of solubility of the binder, evaporation rate of the solvent, and the like, and may be a mixture of plural solvents. In addition, the solvent may be the same as or different from the solvent of the solution-state binder. Examples of the solvent may include without limitation: C₁ to C₁₅ alcohols; C₁ to C₂₀ hydrocarbon solvents such as C₁ to C₂₀ aliphatic hydrocarbons, C₅ to C₂₀ hydrocarbons, C₆ to C₂₀ aromatic hydrocarbons, and the like; halogenated C₁ to C₂₀ hydrocarbon solvents; C₂ to C₂₀ ethers such as C₂ to C₂₀ aliphatic ethers, C₅ to C₂₀ alicyclic ethers, and the like. For example, the solvent may include: alcohol solvents such as methanol, ethanol, propanol, butanol, ethylene glycol, diacetone alcohol, and the like; hydrocarbon solvents such as pentane, hexane, cyclohexane, toluene, xylene, and the like; halogen hydrocarbon solvents such as methylene chloride, trichloroethane, and the like; ethers such as dibutyl ether, dioxane, tetrahydrofuran, propylene glycol methyl ether, and the like, and mixtures thereof.

The amount of the solvent is not limited so long as the amount can allow the binder to be dissolved and can be evaporated after a coating solution is coated. For example, the solvent may be present in an amount of about 100 to about 2,000 parts by weight based on about 100 parts by weight of the binder (in terms of solid content), without being limited thereto.

In exemplary embodiments, the coating solution composition may further include one or more additives used for typical coating solution compositions. Examples of the additives may include without limitation fillers, UV absorbers, hindered amine light stabilizers (HALSs), quenchers, antioxidants, leveling agents, curing agents (initiators), and the like, and mixtures thereof. Among the additives, the filler may be added to further improve abrasion resistance of the coating layer; the UV absorber, the HALS, the quencher, the antioxidant and the like may be added to further improve weather resistance of the coating layer; the leveling agent may be added to improve coatability, slip properties of coating, and the like; and the curing agent may be added to improve abrasion resistance and/or scratch resistance of the coating layer by further improving a degree of cure of the coating layer.

In exemplary embodiments, the fillers may include inorganic fillers (particles) used for typical coating of liquid compositions. Examples of the inorganic fillers may include without limitation silicon oxide, aluminum oxide, cerium oxide, zirconium oxide, zinc oxide, titanium oxide, and the like, and mixtures thereof. In addition, the inorganic fillers may include inorganic fillers surface-treated (coated) with a surface treatment material having a functional group capable of bonding to or interacting with the binder, such as silane coupling agents including 3-glycidoxypropyltrimethoxysilane, 3-glycidoxypropyltriethoxysilane, 3-glycidoxypropylmethyldiethoxysilane, 3-glycidoxypropylmethyldimethoxysilane, 2-(3,4-epoxycyclohexyl)ethyltrimethoxysilane, 2-(3,4-epoxycyclohexyl)ethyltriethoxysilane, and the like, without being limited thereto. For example, the inorganic fillers may include silica (silicon oxide), titanium oxide, zinc oxide and the like, which are surface-treated with a silane coupling agent, such as 3-glycidoxypropyltrimethoxysilane.

In exemplary embodiments, the fillers may have an average particle diameter (D50) of about 1 nm to about 100 nm, for example, about 2 nm to about 50 nm. Within this range, the coating layer can exhibit improved abrasion resistance with minimal or no deterioration in other properties thereof.

In exemplary embodiments, the surface-treated inorganic fillers may have a form in which at least a portion of the inorganic fillers is coated with a surface treating material, for example, a form in which a hydroxyl group of the inorganic fillers is bonded to a functional group of the surface treating material, such as an epoxy group. In addition, the surface treating material may be present in an amount of about 1 to about 50 parts by weight based on about 100 parts by weight of the inorganic fillers, without being limited thereto.

In exemplary embodiments, the fillers may be present in an amount of about 1 to about 300 parts by weight, for example, about 10 to about 115 parts by weight, based on about 100 parts by weight of the binder (in terms of solid content). Within this range, a coating layer exhibiting good adhesion to a substrate and excellent abrasion resistance can be formed.

Examples of the additives excluding the fillers may include without limitation 2,4-dihydroxybenzophenone, 2,3,4-trihydroxybenzophenone, Tinuvin-400 (BASF Co., Ltd.), Tinuvin-479 (BASF Co., Ltd.), Tinuvin 99-2 (BASF Co., Ltd.), ADK STAB 1413 (Adeka Co., Ltd.), LA-31 (Adeka Co., Ltd.), 4,6-dibenzoyl resorcinol, Tinuvin-123 (BASF Co., Ltd.), Tinuvin-292 (BASF Co., Ltd.), Tinuvin-152 (BASF Co., Ltd.), Tinuvin-5151 (BASF Co., Ltd.), hydroquinone, methoxyhydroquinone, Irganox 245 (BASF Co., Ltd.), Irganox 1098 (BASF Co., Ltd.), Irganox 1135 (BASF Co., Ltd.), Irganox 3114 (BASF Co., Ltd.), Irgafos 168 (BASF Co., Ltd.), and the like, and mixtures thereof.

In exemplary embodiments, the additives excluding the fillers may be present in an amount of about 0.01 to about 80 parts by weight based on about 100 parts by weight of the binder (in terms of solid content), without being limited thereto.

In exemplary embodiments, the coating solution composition may be prepared by simply mixing and stirring the components, or may be prepared by preparing a mixture of the binder and the fillers through polymerization of the monomer mixture in the presence of the fillers, followed by mixing and stirring the remaining components such as the phosphorus catalyst and the like, when the fillers are used. When the mixture of the binder and the fillers is prepared and used, it is possible to obtain a coating solution composition in which the fillers are more uniformly dispersed in a binder matrix, and a coating layer in which the fillers can strongly interact with the binder and can exhibit high uniformity of dispersion.

Hereinafter, embodiments of the present invention will be described in more detail with reference to the accompanying drawings. It should be understood that the present invention is not limited to the following embodiments and may be embodied in different ways, and that the embodiments are provided for complete disclosure and thorough understanding of the invention by those skilled in the art. In the drawings, the sizes of components, such as widths, thicknesses and the like, may be exaggerated for clarity. In addition, although only some portions of the components are illustrated for convenience, the remaining portions of the components can also be easily understood by those skilled in the art. Descriptions related to the drawings are made based on a point of view of an observer. It will be understood that when an element such as a layer, film, region or substrate is referred to as being placed “on” another element, it can be directly placed on the other element, or intervening layer(s) may also be present. It should be understood that various modifications, changes, alterations, and equivalent embodiments can be made by those skilled in the art without departing from the spirit and scope of the invention. Like components will be denoted by like reference numerals throughout the specification.

According to the present invention, a molded article includes a coating layer formed from the coating solution composition as set forth above.

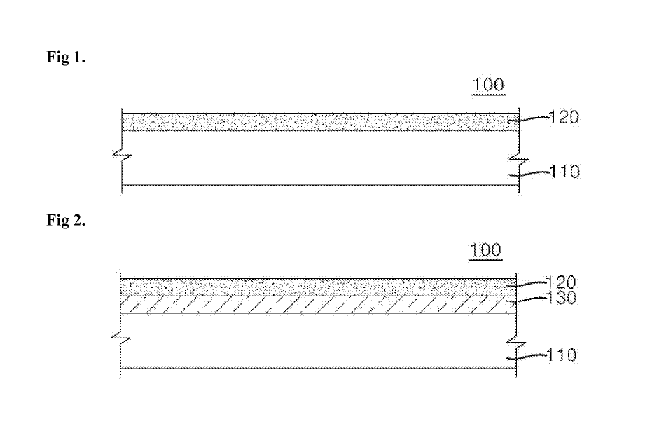

FIG. 1 shows a sectional view of a molded article (polycarbonate glazing) according to one embodiment of the present invention. Referring to FIG. 1, a polycarbonate glazing 100 includes a polycarbonate substrate 110, and a coating layer 120 formed on at least one surface of the substrate 110. Here, the coating layer 120 is a cured product of the coating solution composition as set forth above.

The polycarbonate substrate 110 may include typical polycarbonate resins. For example, the polycarbonate substrate 110 may be a polycarbonate, a polycarbonate copolymer, or a blended polycarbonate resin. The blended resin may be a resin obtained by blending a polycarbonate with a polymeric resin such as polyamide, thermoplastic polyurethane (TPU), acrylonitrile-styrene-acrylonitrile, polymethylmethacrylate, polyester, acrylonitrile-butadiene-styrene resins, and the like, and mixtures thereof, without being limited thereto. The polycarbonate may be prepared by reacting a dihydric phenol compound with phosgene or by esterification and/or transesterification of a dihydric phenol compound and a carbonate precursor such as diphenyl carbonate, in the presence of a molecular weight regulator and a catalyst, according to a typical preparation method. In this polycarbonate preparation method, the dihydric phenol compound may be a bisphenol compound, for example, 2,2-bis(4-hydroxyphenyl)propane (“bisphenol A”). Here, bisphenol A may be partially or wholly replaced with another dihydric phenol compound.

In exemplary embodiments, in terms of safety and transparency for a substrate for polycarbonate glazing, the polycarbonate resin may have a tensile strength of about 60 MPa or more, a tensile modulus of about 1.5 GPa or more, a Vicat softening point of about 120° C. or more, and a total light transmittance of about 80% or more, without being limited thereto.

In exemplary embodiments, the polycarbonate substrate 110 may have a thickness of about 1 mm to about 50 mm, for example, about 1 mm to about 10 mm. Within this range, the polycarbonate substrate can exhibit excellent mechanical strength, availability, and transparency, as a glazing substrate.

According to the present invention, the coating layer 120 is obtained by coating the coating solution composition as set forth above, followed by curing. Curing of the coating solution composition can be performed by a typical curing method using heat and/or UV. Upon curing, the coating solution composition forms a network structure as a degree of curing is increased due to crosslinking in the binder matrix containing the inorganic fillers.

In exemplary embodiments, the coating layer 120 may be formed in a single layer structure or in a stack structure of two layers or more.

In addition, the coating layer 120 may have a thickness of about 0.1 μm to about 20 μm, for example, about 1 μm to about 10 μm. Within this range, the polycarbonate glazing 100 can exhibit excellent abrasion resistance, scratch resistance and the like, and can obtain reliability due to excellent adhesion thereof to the substrate 110.

FIG. 2 shows a sectional view of a polycarbonate glazing according to another embodiment of the present invention. Referring to FIG. 2, the polycarbonate glazing 100 may further include a primer layer 130 between the polycarbonate substrate 110 and the coating layer 120.

The primer layer 130 can provide functions such as coupling (improvement in bonding strength) and stress relief of the substrate 110 and the coating layer 120, crack prevention and the like, and can help improve long-term reliability of the polycarbonate glazing.

In exemplary embodiments, the primer layer 130 may be a primer layer used for typical polycarbonate glazing, and may be formed by a method of primer coating or film insert molding and curing, and the like, without being limited thereto. The primer layer 130 may be formed of a typical primer layer-forming material (primer). The primer layer-forming material may include, for example, at least one of organopolysiloxane resins, acrylic resins, epoxy resins, polyester resins, polyurethane resins, copolymers thereof, and blended resins obtained by combination thereof, without being limited thereto. For example, the primer layer-forming material may include an epoxy resin, an acrylic resin, a copolymer such as urethane-acrylate resins, and the like. In addition, the resins may be included in a monomer form in the primer layer-forming material. Further, the primer layer 130 may have a stack structure of layers containing the same or different forming materials for purposes of improvement in interlayer adhesion, and the like. The primer layer-forming material and a method for manufacturing the primer layer are well known among those skilled in the art.

In another embodiment, the primer layer 130 may be formed of a primer layer-forming material including the binder and the like used for the coating solution composition according to the present invention. In addition, the primer layer-forming material may further include the inorganic fillers, the additives and/or the solvent used for the coating solution composition according to the present invention, without being limited thereto. That is, in another embodiment, the primer layer 130 may be one portion of the coating layer 120 having a stack structure of layers containing the same or different components.

In the primer layer-forming material according to another embodiment of the present invention, the binder used in the primer layer may include a polymer of a monomer mixture including: about 10 mol % to about 90 mol %, for example, about 20 mol % to about 59.9 mol %, of the compound represented by Formula 1; about 10 mol % to about 90 mol %, for example, about 40 mol % to about 79.9 mol %, of the compound represented by Formula 2; and optionally about 10 mol % or less, for example, about 0.1 mol % to about 3 mol %, of the compound represented by Formula 3, each amount based on the 100 mol % of the monomer mixture.

In some embodiments, the monomer mixture of the primer layer-forming material may include the compound represented by Formula 1 in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 mol %. Further, according to some embodiments of the present invention, the compound represented by Formula 1 may be present in an amount of from about any of the foregoing amounts to about any other of the foregoing amounts.

In some embodiments, the monomer mixture of the primer layer-forming material may include the compound represented by Formula 2 in an amount of about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90 mol %. Further, according to some embodiments of the present invention, the compound represented by Formula 2 may be present in an amount of from about any of the foregoing amounts to about any other of the foregoing amounts.

In some embodiments, the monomer mixture of the primer layer-forming material may include the compound represented by Formula 3 in an amount of 0 (the compound of Formula 3 is not present), about 0 (the compound of Formula 3 is present), 0.1, 0.2, 0.3, 0.4, 0.5, 0.6, 0.7, 0.8, 0.9, 1, 2, 3, 3, 4, 5, 6, 7, 8, 9, or 10 mol %. Further, according to some embodiments of the present invention, the compound represented by Formula 3 may be present in an amount of from about any of the foregoing amounts to about any other of the foregoing amounts.

Within these ranges, the coating layer (glazing) can exhibit excellent abrasion resistance and the like.

In addition, the phosphorus catalyst may be present in an amount of about 0.01 to about 25 parts by weight, for example, about 0.1 to about 15 parts by weight, based on about 100 parts by weight of the binder (in terms of solid content). Within this range, the primer layer can exhibit an excellent degree of curing upon formation thereof.

Further, when the primer layer-forming material further includes the inorganic fillers, the additives and/or the solvent, the inorganic fillers may be present in an amount of about 300 parts by weight or less, for example, about 0.01 to about 115 parts by weight, and as another example about 10 to about 100 parts by weight, based on about 100 parts by weight of the binder (in terms of solid content); the additives may be present in an amount of about 0.01 to about 80 parts by weight, for example, about 1 to about 80 parts by weight, based on about 100 parts by weight of the binder (in terms of solid content); and the solvent may be present in an amount of about 100 to about 2,000 parts by weight, for example, about 150 to about 900 parts by weight, based on about 100 parts by weight of the binder (in terms of solid content). Within these ranges, the binder and the mixing components of the primer can be dissolved and/or dispersed well, and the primer can exhibit excellent coatability since evaporation is facilitated after the primer is coated.

In exemplary embodiments, the primer layer 130 may have a thickness of about 0.1 μm to about 20 μm, for example, about 0.5 μm to about 10 μm. Within this range, the primer layer can obtain reliability due to excellent adhesion to the substrate 110 and the coating layer 120, and can be more effective for abrasion resistance, stress relaxation, crack prevention and the like.

In exemplary embodiments, the polycarbonate glazing 100 may be formed through formation of the coating layer 120 by coating the coating solution composition onto at least one surface of the polycarbonate substrate 110, followed by curing.

The coating solution composition may be coated by a coating method such as bar coating, roll coating, spin coating, dip coating, flow coating, spray coating, and the like, without being limited thereto.

Curing may be thermal curing or UV curing. Although UV curing is advantageous for small sizes, thermal curing is increasingly used with increasing size of molded articles in recent years. In one embodiment, curing may be performed by heat treatment (heating) at about 100° C. to about 140° C., for example, about 110° C. to about 130° C., for example, for about 1 minute to about 180 minutes. Within this temperature range, a coating layer exhibiting excellent abrasion resistance can be formed.

In another embodiment, the polycarbonate glazing 100 may be formed through formation of the primer layer 130 on at least one surface of the polycarbonate substrate 110, and formation of the coating layer 120 by coating the coating solution composition onto a surface of the primer layer 130, followed by curing. Here, formation of the coating layer 120 may be performed in the same manner as in the above embodiment.

In exemplary embodiments, the primer layer 130 may be formed by a typical method, for example, by depositing a primer layer-forming material (primer) or film insert molding, followed by curing. The primer may be coated by a typical coating method such as bar coating, roll coating, spin coating, dip coating, flow coating, spray coating, and the like. In addition, curing may be performed at about 80° C. to about 150° C. for about 1 minute to about 180 minutes, without being limited thereto.

Since the plastic glazing according to the present invention can exhibit excellent adhesion to the substrate and the coating layer, and can exhibit excellent properties in terms of abrasion resistance, weather resistance, scratch resistance, reliability and the like, the plastic glazing is suitable for purposes of glazing for vehicles, for example, windows for vehicles.

Hereinafter, the present invention will be described in more detail with reference to the following examples. It should be understood that these examples are provided for illustration only and are not to be construed in any way as limiting the present invention. A description of details apparent to those skilled in the art will be omitted for clarity.

### EXAMPLES

### Preparative Example 1

### Preparation of Primer Layer-Forming Material (P-1)

130.04 g of isopropyl alcohol, 2.79 g of acetic acid, 109.18 g of colloidal silica (Ludox® TMA, Sigma-Aldrich Co., Ltd.) and 52.82 g of 3-glycidoxypropyltrimethoxysilane are introduced into a 1 L 3-neck flask in order, followed by dropping 30.45 g of methyltrimethoxysilane and 46.78 g of 2-hydroxy-4-(3-methyldiethoxysilylpropoxy)diphenylketone into the flask over the course of 60 minutes at 25° C. After completion of dropping, the components are stirred at 50° C. for 12 hours. After completion of stirring, the flask is cooled to room temperature, followed by addition of normal butyl alcohol until the amount of a binder solid reaches 20% by weight (wt %). Next, 1 part by weight of triphenylphosphine is introduced based on 100 parts by weight of the binder solid, followed by stirring at 25° C. for 1 hour, thereby preparing a primer layer-forming material P-1. As a result of measurement of the obtained primer layer-forming material by gel permeation chromatography (GPC), a siloxane resin included in the primer layer-forming material has a weight average molecular weight of 4,000 g/mol.

### Preparative Example 2

### Preparation of Primer Layer-Forming Material (P-2) 129.9 g of isopropyl alcohol, 3.69 g of acetic acid, 99.53 g of colloidal silica

(Ludox® TMA, Sigma-Aldrich Co., Ltd.) and 69.70 g of 3-glycidoxypropyltrimethoxysilane are introduced into a 1 L 3-neck flask in order, followed by dropping 60.26 g of methyltrimethoxysilane into the flask over the course of 60 minutes at 25° C. After completion of dropping, the components are stirred at 50° C. for 12 hours. After completion of stirring, the flask is cooled to room temperature, followed by addition of normal butyl alcohol until the amount of a binder solid reaches 20 wt %. Next, 20 parts by weight of 2-hydroxy-4-(3-methyldiethoxysilylpropoxy)diphenylketone as a UV absorber and 1 part by weight of triphenylphosphine are introduced based on 100 parts by weight of the binder solid, followed by stirring at 25° C. for 1 hour, thereby preparing a primer layer-forming material P-2. As a result of measurement of the obtained primer layer-forming material by gel permeation chromatography (GPC), a siloxane resin included in the primer layer-forming material has a weight average molecular weight of 4,100 g/mol.

### Example 1

### Preparation of Coating Solution Composition (C-1)

132.12 g of isopropyl alcohol, 4.73 g of acetic acid, 83.73 g of colloidal silica (Ludox® TMA, Sigma-Aldrich Co., Ltd.) and 4.47 g of 3-glycidoxypropyltrimethoxysilane are introduced into a 1 L 3-neck flask in order, followed by dropping 125.67 g of methyltrimethoxysilane and 1.98 g of 2-hydroxy-4-(3-methyldiethoxysilylpropoxy)diphenylketone into the flask over the course of 60 minutes at 25° C. After completion of dropping, the components are stirred at 50° C. for 12 hours. Then, the flask is cooled to room temperature, followed by addition of normal butyl alcohol until the amount of a binder solid reaches 25 wt %. Next, 1 part by weight of triphenylphosphine as a phosphorus catalyst is introduced based on 100 parts by weight of the binder solid, followed by stirring at 25° C. for 1 hour, thereby preparing a coating solution composition C-1. As a result of measurement of the obtained coating solution composition by gel permeation chromatography (GPC), a siloxane resin included in the coating solution composition has a weight average molecular weight of 2,500 g/mol.

### Example 2

### Preparation of Coating Solution Composition (C-2)

132.14 g of isopropyl alcohol, 4.72 g of acetic acid, 83.76 g of colloidal silica (Ludox® TMA, Sigma-Aldrich Co., Ltd.) and 4.69 g of glycidoxypropylmethyldiethoxysilane are introduced into a 1 L 3-neck flask in order, followed by dropping 125.47 g of methyltrimethoxysilane and 1.98 g of 2-hydroxy-4-(3-methyldiethoxysilylpropoxy)diphenylketone into the flask over the course of 60 minutes at 25° C. After completion of dropping, the components are stirred at 50° C. for 12 hours. Then, the flask is cooled to room temperature, followed by addition of normal butyl alcohol until the amount of a binder solid reaches 25 wt %. Next, 1 part by weight of triphenylphosphine is introduced based on 100 parts by weight of the binder solid, followed by stirring at 25° C. for 1 hour, thereby preparing a coating solution composition C-2. As a result of measurement of the obtained coating solution composition by gel permeation chromatography (GPC), a siloxane resin included in the coating solution composition has a weight average molecular weight of 2,600 g/mol.

### Example 3

### Preparation of Coating Solution Composition (C-3)

50.0 g of Tinuvin-400 (BASF Co., Ltd.) and 150 ml of toluene are introduced into a 1 L round flask and mixed. The mixture is washed with 150 ml of distilled water three times using a separatory funnel, followed by collection of an organic layer, and then subjected to concentration under reduced pressure, thereby completely drying the mixture. 85 ml of tetrahydrofuran is introduced into the obtained concentrate and dissolved, followed by further introduction of 17.06 g of 3-(triethoxysilyl)propylisocyanate and 1.0 g of a 5% tetrahydrofuran solution in which dibutyltin dilaurate is dissolved. The components are reacted at 65° C. for 3 hours under reflux, followed by cooling to room temperature. Completion of reaction is confirmed through NMR. The obtained solution is completely dried under reduced pressure, thereby obtaining Tinuvin-400-derived triethoxysilane (corresponding to the compound represented by Formula 3) as a solid.

Next, 131.83 g of isopropyl alcohol, 4.64 g of acetic acid, 85.28 g of colloidal silica (Ludox® TMA, Sigma-Aldrich Co., Ltd.) and 4.39 g of 3-glycidoxypropyltrimethoxysilane are introduced into a 1 L 3-neck flask in order, followed by dropping 123.29 g of methyltrimethoxysilane and 4.15 g of Tinuvin-400-derived triethoxysilane into the flask over the course of 60 minutes at 25° C. After completion of dropping, the components are stirred at 50° C. for 12 hours. Then, the flask is cooled to room temperature, followed by addition of normal butyl alcohol until the amount of a HI binder solid reaches 25 wt %. Next, 1 part by weight of triphenylphosphine is introduced based on 100 parts by weight of the binder solid, followed by stirring at 25° C. for 1 hour, thereby preparing a coating solution composition C-3. As a result of measurement of the obtained coating solution composition by gel permeation chromatography (GPC), a siloxane resin included in the coating solution composition has a weight average molecular weight of 2,400 g/mol.

### Comparative Example 1

### Preparation of Coating Solution Composition (C-4)

132.14 g of isopropyl alcohol, 4.78 g of acetic acid, 83.15 g of colloidal silica (Ludox® TMA, Sigma-Aldrich Co., Ltd.) and 4.52 g of 3-glycidoxypropyltrimethoxysilane are introduced into a 1 L 3-neck flask in order, followed by dropping 127.62 g of methyltrimethoxysilane into the flask over the course of 60 minutes at 25° C. After completion of dropping, the components are stirred at 50° C. for 12 hours. Then, the flask is cooled to room temperature, followed by addition of normal butyl alcohol until the amount of a binder solid reaches 25 wt %. Next, 0.5 parts by weight of 2-hydroxy-4-(3-methyldiethoxysilylpropoxy)diphenylketone as a UV absorber and 1 part by weight of triphenylphosphine are introduced based on 100 parts by weight of the binder solid, followed by stirring at 25° C. for 1 hour, thereby preparing a coating solution composition C-4. As a result of measurement of the obtained coating solution composition by gel permeation chromatography (GPC), a siloxane resin included in the coating solution composition has a weight average molecular weight of 2,500 g/mol.

### Examples 4 to 6 and Comparative Example 2

### Manufacture of Molded Article

According to Table 1, each of the coating solution compositions (Examples 1 to 3 and Comparative Example 1) is coated onto one surface of a polycarbonate substrate (model: LEXAN, GE Co., Ltd.) having a size of 30 cm×20 cm×3 mm using a Mayer bar. After coating, each of the coating solution compositions is subjected to leveling at room temperature for 20 minutes, followed by thermal curing in an oven at 130° C. for 1 hour, thereby forming a 5 μm thick coating layer. The manufactured molded article (polycarbonate glazing specimen) is evaluated as to the following properties. Results are shown in Table 1.

### Examples 7 to 12 and Comparative Examples 3 to 4

### Manufacture of Molded Article

According to Table 1, each of the primer layer-forming materials of Preparative Examples 1 to 2 is coated onto one surface of a polycarbonate substrate (model: LEXAN, GE Co., Ltd.) having a size of 30 cm×20 cm×3 mm using a Mayer bar. After coating, each of the primer layer-forming materials is subjected to leveling at room temperature for 20 minutes, followed by thermal curing in an oven at 130° C. for 30 minutes, thereby forming a 3 μm thick primer layer. Next, according to Table 1, each of the coating solution compositions is coated onto one surface of the primer layer, followed by leveling at room temperature for 20 minutes and then thermal curing in an oven at 130° C. for 1 hour, thereby forming a 5 μm thick coating layer. The manufactured molded article (polycarbonate glazing specimen) is evaluated as to the following properties. Results are shown in Table 1.

Property Evaluation

1. Thickness (unit: μm): Thicknesses of the coating layer and the primer layer are measured using an F-20 (Filmetics Co., Ltd.). After measurement five times, an average value is calculated.

2. Abrasion resistance: The manufactured polycarbonate glazing is subjected to abrasion 500 times under conditions of a CS-10F abrasion wheel and a load of 500 g using a Taber Abraser (model: 5135, Gardoco Co., Ltd.). A difference in haze (ΔHaze, unit: %) before and after abrasion is measured using a haze meter (model: NDH 5000, Nippon Denshoku Co., Ltd.), thereby evaluating abrasion resistance.

3. Adhesion: By the cross-hatch test method, grid-shaped gradations are made by drawing lines at intervals of 2 mm on a specimen, followed by marking 100 points. A tape is attached to the specimen, followed by strongly pulling the tape once in a vertical direction. Then, the number of point-marked pieces of the specimen, which are not peeled off, is counted.

4. Weather resistance: Using a Weather-Ometer (model: Ci4000, Atlas Co., Ltd.), a specimen is left under SAE J1960 standard conditions for 1,000 hours, followed by performing appearance evaluation and measurement of change in yellow index (ΔYI). The specimen having suffered from neither interlayer peeling nor cracking on an overall surface thereof is rated as OK, and the specimen having suffered from even slight interlayer peeling or a few cracks is rated as Crack. In addition, using a spectrophotometer (model: CM-3600d, Konica-Minolta Co., Ltd.), a yellow index (YI) of the specimen before and after lightfastness testing is measured, followed by calculation of a yellow index difference between before and after lightfastness testing to measure change in yellow index.

TABLE 1

| | | | Abrasion | | | |
|---|---|---|---|---|---|---|
| | | Coating | resistance | | Weather resistance | |
| | Primer layer- | solution | Difference | | | Difference |
| | forming material | composition | in haze | Adhesion | Appearance | in YI |
| Example 4 | — | Example 1 | 3.5 | 100/100 | OK | 0.9 |
| Example 5 | — | Example 2 | 3.7 | 100/100 | OK | 0.8 |
| Example 6 | — | Example 3 | 3.7 | 100/100 | OK | 1.0 |
| Example 7 | Preparative Example 1 | Example 1 | 2.2 | 100/100 | OK | 0.4 |
| Example 8 | Preparative Example 1 | Example 2 | 3.5 | 100/100 | OK | 0.6 |
| Example 9 | Preparative Example 1 | Example 3 | 2.6 | 100/100 | OK | 0.5 |
| Example 10 | Preparative Example 2 | Example 1 | 1.8 | 100/100 | OK | 0.5 |
| Example 11 | Preparative Example 2 | Example 2 | 3.2 | 100/100 | OK | 0.8 |
| Example 12 | Preparative Example 2 | Example 3 | 2.1 | 100/100 | OK | 0.7 |
| Comparative | — | Comparative | 4.6 | 100/100 | crack | 3.5 |
| Example 2 | | Example 1 | | | | |
| Comparative | Preparative Example 1 | Comparative | 4.9 | 100/100 | OK | 1.3 |
| Example 3 | | Example 1 | | | | |
| Comparative | Preparative Example 2 | Comparative | 4.3 | 100/100 | crack | 2.7 |
| Example 4 | | Example 1 | | | | |

From the results, it can be seen that the polycarbonate glazing according to the present invention exhibits excellent properties in terms of abrasion resistance, adhesion, weather resistance and the like.

On the other hand, it can be seen that the polycarbonate glazing of Comparative Examples exhibits great difference in haze (ΔHaze, 4.3% or more) between before and after the abrasion test as compared with those of Examples. This means that abrasion resistance of the coating layers of Comparative Examples is deteriorated as compared with those of Examples. In addition, the coating layers of Comparative Examples suffer from cracking or exhibit greater change in yellow index (ΔYI) than those of Examples. This means that weather resistance of the coating layers of Comparative Examples is deteriorated as compared with those of Examples.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. Therefore, the scope of the present invention should be defined by the appended claims and equivalents thereof.

What is claimed is:

1. A siloxane resin which is a polymer of a monomer mixture comprising a compound represented by Formula 1, a compound represented by Formula 2, and a compound represented by Formula 3: 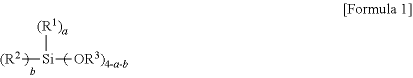
where R¹ is an epoxy or glycidoxy group-containing C₁ to C₁₂ alkyl group, R² is a hydrogen atom or a substituted or unsubstituted C₁ to C₁₀ alkyl group, R³ is a substituted or unsubstituted C₁ to C₁₀ alkyl group, an average value of a is 1 to 3, an average value of b is 0 to 2, and an average value of a+b is 1 to 3;
R⁴—SiOR⁵)₃ [Formula 2]
where R⁴ is a hydrogen atom or a substituted or unsubstituted C₁ to C₁₀ alkyl group, and R⁵ is a substituted or unsubstituted C₁ to C₁₀ alkyl group;
R⁶—SiOR⁷)₃ [Formula 3]
where R⁶ is a UV absorbing functional group or a UV absorbing functional group-containing group, and R⁷ is a substituted or unsubstituted C₁ to C₁₀ alkyl group.

2. The siloxane resin according to claim 1, wherein the UV absorbing functional group comprises a substituted or unsubstituted benzotriazole group, substituted or unsubstituted benzophenone group, substituted or unsubstituted triazine group, substituted or unsubstituted salicylate group, substituted or unsubstituted cyanoacrylate group, substituted or unsubstituted oxanilide group or a combination thereof.

3. The siloxane resin according to claim 1, wherein the monomer mixture comprises the compound represented by Formula 1 in an amount of about 0.50 mol % to about 99.45 mol %, the compound represented by Formula 2 in an amount of about 0.50 mol % to about 99.45 mol %, and the compound represented by Formula 3 in an amount of about 0.05 mol % to about 10 mol %, each based on a total of 100 mol % of the monomer mixture.

4. The siloxane resin according to claim 1, wherein the monomer mixture further comprises a compound represented by Formula 4:
(R⁸_{c}SiOR⁹)_{4-c} [Formula 4]
where R⁸ is a hydrogen atom or a substituted or unsubstituted C₁ to C₁₀ alkyl group; R⁹ is a substituted or unsubstituted C₁ to C₁₀ alkyl group; and c is 0, 2 or 3.

5. The siloxane resin according to claim 1, wherein the polymer has a weight average molecular weight of about 800 g/mol to about 30,000 g/mol.

6. A coating solution composition comprising:
a binder comprising the siloxane resin according to claim 1; and
a phosphorus catalyst.

7. The coating solution composition according to claim 6, wherein the phosphorus catalyst comprises a compound represented by Formula 5: 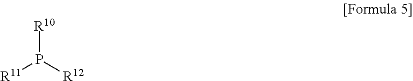
where R¹⁰, R¹¹ and R¹² are the same or different and are each independently a substituted or unsubstituted C₁ to C₂₀ hydrocarbon group.

8. The coating solution composition according to claim 6, comprising the phosphorus catalyst in an amount of about 0.01 to about 25 parts by weight based on about 100 parts by weight of the siloxane resin.

9. The coating solution composition according to claim 6, further comprising: a solvent.

10. The coating solution composition according to claim 6, further comprising a filler, UV absorber, quencher, hindered amine light stabilizer, antioxidant, leveling agent, or a combination thereof.

11. A molded article comprising:
a polycarbonate substrate; and
a coating layer formed on at least one surface of the substrate,
wherein the coating layer is a cured product of a coating solution composition which comprises: a binder comprising the siloxane resin according to claim 1; and a phosphorus catalyst.

12. The molded article according to claim 11, wherein the polycarbonate substrate has a thickness of about 1 mm to about 50 mm, and the coating layer has a thickness of about 0.1 μm to about 20 μm.

13. The molded article according to claim 11, further comprising:
a primer layer formed between the polycarbonate substrate and the coating layer.
